(19) United States
(12) Patent Application Publication
(10) Pub. No.: US 2011/0013204 A1
(43) Pub. Date: Jan. 20, 2011

(54) Printer

(76) Inventor: Yuji Nakagaki, Narashino-shi (JP)

Correspondence Address: CROWELL & MORING LLP;INTELLECTUAL PROPERTY GROUP, P.O. BOX 14300, WASHINGTON, DC, 20044-4300, US

(21) Appl. No.: 12/667,800

(22) PCT Filed: Jul. 2, 2008
(86) PCT No.: PCT/JP2008/061980

§ 371 Date: Jan. 5, 2010

(30) Foreign Application Priority Data
Jul. 6, 2007 (JP) 2007-178941

(51) Int. Cl. G06K 15/10

(52) U.S. Cl. 358/1.8

(57) ABSTRACT

An inkjet printer comprises a platen roller (22) for holding a print medium (50), a print head (12) performing printing at a print position by ejecting ink from nozzle holes toward the print medium (50) held by the platen roller (22), a supporting member (18) for supporting the print head (12), and a pressing section for pressing the print head (12) against the supporting member (18). The supporting member (18) is disposed at a position facing opposite ends of the print head (12). At the time of printing, the print head (12) is pressed against the supporting member (18) and thus vibration of the print head (12) is suppressed.

### TECHNICAL FIELD

The present invention relates to a printer, and more particularly, to an inkjet printer.

### BACKGROUND ART

In an inkjet printer, when ink adhering to a print head or ink resident in a print head is neglected, the ink is solidified, and the solidified ink blocks nozzle holes. Consequently, an inkjet printer has been proposed where a cap is installed on the print head to prevent ink from being solidified, while in addition, a maintenance mechanism (cleaning mechanism) that cleans the print head is also provided (see Patent Literature 1, for example).

In the inkjet printer disclosed in Patent Literature 1, the print head is transported between a print position (i.e., a position facing a print medium on the platen) and a maintenance position (i.e., a cleaning position; a position where the print head is cleaned by the maintenance mechanism).
Patent Literature 1: Unexamined Japanese Application KOKAI Publication No. 2007-90612

### DISCLOSURE OF THE INVENTION

### Problem to be Solved by the Invention

In the configuration described in Patent Literature 1, when the print head is transported between the print position and the maintenance position, a vertical transport mechanism transports the print head vertically, and a horizontal transport mechanism transports the print head horizontally. The vertical transport mechanism is installed orthogonally to the horizontal transport mechanism, and the print head is installed parallel to the vertical transport mechanism. The vertical transport mechanism is slidably installed on guide axes of the horizontal transport mechanism, and the print head is slidably installed on guide axes of the vertical transport mechanism.

However, the printer vibrates due to components such as a motor, a rotating platen roller, and a feed roller for feeding the print medium, and a cutter for cutting the print medium, for example. Since the horizontal transport mechanism and the print head are slidably installed onto the vertical transport mechanism and the horizontal transport mechanism, respectively, the print head vibrates when the printer vibrates, and there is a concern that print quality may degrade.

Being devised in light of the foregoing circumstances, the present invention has as an object to provide a printer able to suppress degradation of print quality due to vibration of the print head.

### Means for Solving the Problem

In order to achieve the above object, a printer in accordance with the present invention is provided with: a platen that holds a print medium; a print head that prints at a predetermined print position by ejecting ink from nozzle holes toward the print medium held by the platen; a supporting member that supports the print head; and a pressing section that presses the print head against the supporting member.

For example, the supporting member may be disposed at a position facing opposite ends of the print head. The pressing section then presses the print head against the supporting member such that the opposite ends of the print head contact the supporting member.

For example, the supporting member may support the print head at the print position. The pressing section then presses the print head against the supporting member at the print position.

As a result of the pressing section pressing the print head against the supporting member, vibration of the print head is suppressed.

For example, in order to prevent ink resident in the print head from being solidified, there may be provided an ejected ink receptacle, disposed at a predetermined ejection position, that absorbs and retains ink ejected and discarded by the print head, as well as a transporting section that transports the print head between the print position and the ejection position. In this case, the supporting member is configured from a flat guide extending between the print position and the ejection position, and supports the print head between the print position and the ejection position. The pressing section then presses the print head against the supporting member between the print position and the ejection position.

The transporting section transports the print head and the pressing section between the print position and the ejection position. While being transported between the print position and the ejection position by the transporting section, the pressing section presses the print head against the supporting member.

For example, a cleaning mechanism that cleans the print head may also be provided. The transporting section then transports the print head among the print position, the ejection position, and a cleaning position where the print head is cleaned by the cleaning mechanism.

### Advantages of the Invention

According to the present invention, a printer which is able to suppress degradation of print quality due to vibration of the print head, can be provided.

### BRIEF DESCRIPTION OF DRAWINGS

FIG. 1 is a partial perspective view of an inkjet printer in accordance with an embodiment of the present invention.

FIG. 2 is a cross-section view of an inkjet printer in accordance with an embodiment of the present invention.

FIG. 3 is a cross-section view of the print unit of an inkjet printer in accordance with an embodiment of the present invention, showing the state wherein the print head is in the print position.

FIG. 4 is a cross-section view of the print unit of an inkjet printer in accordance with an embodiment of the present invention, showing the state wherein the print head is in the ejection position.

FIG. 5A is a front cross-section diagram illustrating the installation structure of a print head installed on a print head carrier, showing the state wherein the print head is contacting the supporting member.

FIG. 5B is a lateral cross-section diagram illustrating the installation structure of a print head installed on a print head carrier, showing the state wherein the print head is contacting the supporting member.

FIG. 5C is a front cross-section diagram illustrating the installation structure of a print head installed on a print head carrier, showing the state wherein the print head is not contacting the supporting member.

FIG. 5D is a lateral cross-section diagram illustrating the installation structure of a print head installed on a print head carrier, showing the state wherein the print head is not contacting the supporting member.

FIG. 6 is a cross-section view of an ejected ink receptacle.

FIG. 7A is a diagram illustrating a modification of the print head and the supporting member.

FIG. 7B is a diagram illustrating a modification of the print head and the supporting member.

### EXPLANATION OF SYMBOLS

1 inkjet printer

10 print unit

11 chassis

12 print head

12a slide hole

12b large-diameter section

13 maintenance mechanism (cleaning mechanism)

131 cap unit

132 wiper unit

133 cleaner unit

14 nozzle surface

15 print head carrier

15a shaft (slide pin)

15b coil spring

15c large-diameter section

16 horizontal transport mechanism

17 vertical transport mechanism

18 supporting member

19 ejected ink receptacle

20 feed unit

21 feed roller

22 platen roller

40 control unit

50 print medium

60 print head apparatus

### BEST MODE FOR CARRYING OUT THE INVENTION

Hereinafter, an inkjet printer in accordance with an embodiment of the present invention will be described with reference to the accompanying drawings.

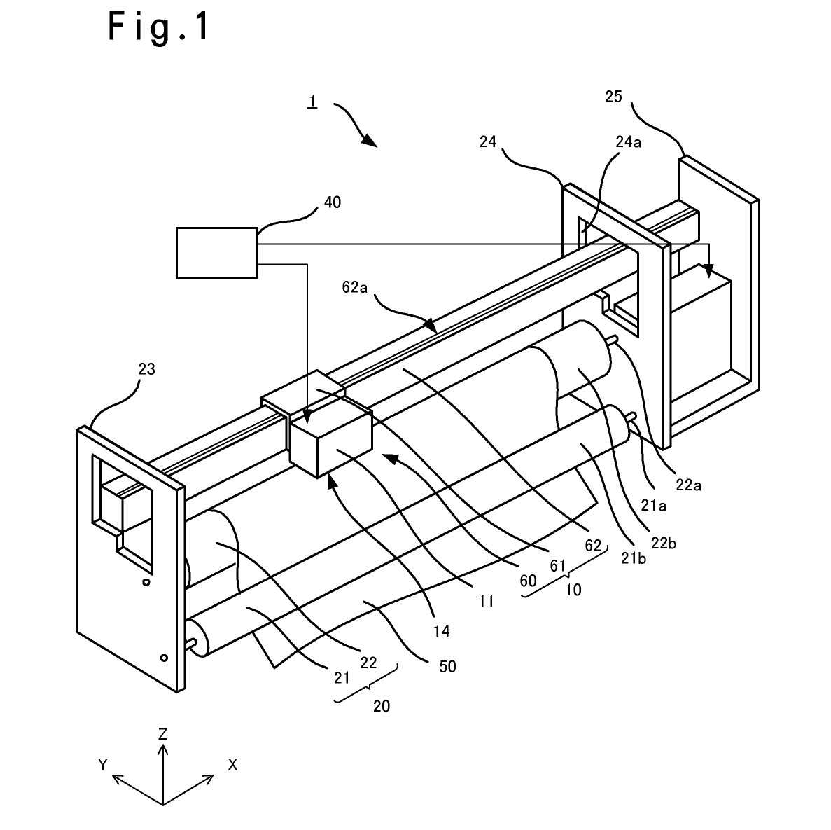

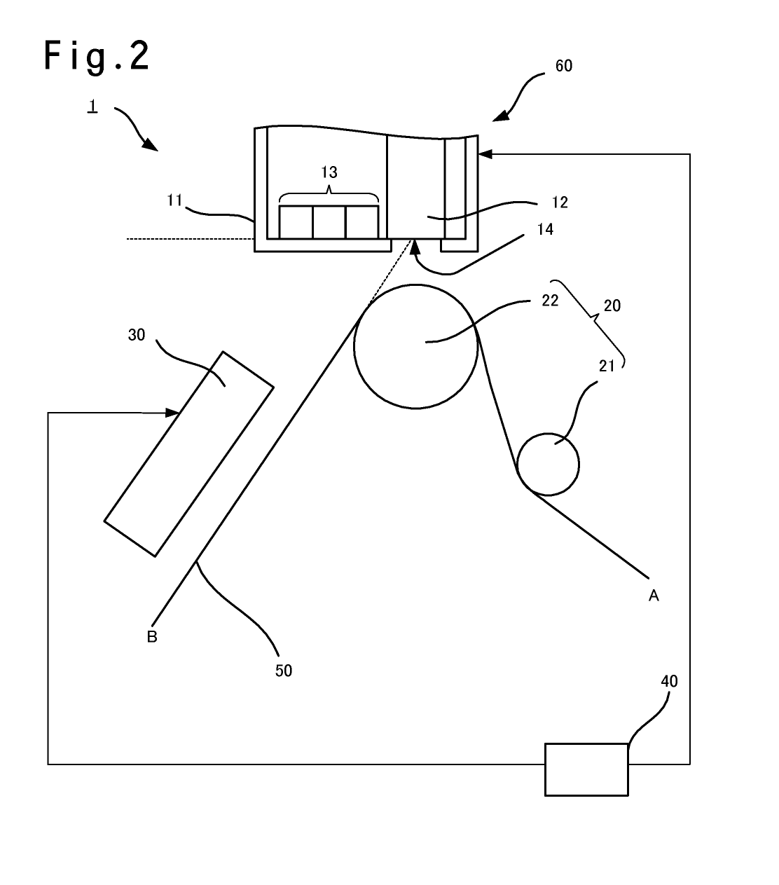

FIG. 1 is a partial perspective view of an inkjet printer 1 in accordance with an embodiment of the present invention. FIG. 2 is a cross-section view of the inkjet printer 1.

As illustrated in FIGS. 1 and 2, the inkjet printer 1 is made up of a print unit 10, a feed unit 20, a heating unit 30, and a control unit 40.

The print unit 10 includes a print head apparatus 60, a holder 61, and a holder guide 62.

The print head apparatus 60 houses components such as the print head 12 and the maintenance mechanism (cleaning mechanism) 13 in the interior of the chassis 11, and prints by ejecting ink from the print head 12 toward a print medium 50.

The chassis 11 is a member with an approximately rectangular solid shape that houses components such as the print head 12 and the maintenance mechanism 13. The chassis 11 includes an aperture (not shown in the drawings) on the bottom surface, that exposes the nozzle surface 14 of the print head 12.

The holder 61 removably holds the print head apparatus 60. The holder 61 is joined to a belt (not shown in the drawings) driven by a motor not shown in the drawings. The holder 61 is configured to be movable in the X direction (i.e., the lengthwise direction of the platen roller 22) along a guide rail 62a formed on the holder guide 62.

The holder guide 62 is a member with an approximately rectangular solid shape extending in the X direction. On the top surface of the holder guide 62 (the Z direction (i.e., the direction in which the print head 12 moves close to and away from the platen roller 22)), the guide rail 62a is formed along the lengthwise direction (X direction). The holder guide 62 passes through a window 24a in a floor board 24, with both ends secured to a floor board 23 and a support board 25.

The feed unit 20 includes a feed roller 21 and a platen roller 22, and carries the print medium 50 in at the A end and out at the B end.

The feed roller 21 includes an axis 21a and a cylindrical rotating section 21b. The axis 21a is disposed approximately horizontally in the X direction, with both ends secured to the floor boards 23 and 24, respectively. The rotating section 21b is rotatably disposed around the secured axis 21a thus fixed.

The platen roller 22 includes an axis 22a and a cylindrical rotating section 22b. The axis 22a is disposed approximately horizontally in the X direction, with both ends rotatably supported by the floor boards 23 and 24, respectively.

The floor boards 23 and 24 are disposed parallel to each other and orthogonal to the axes 21a and 22a.

The heating unit 30 is disposed on the B-end side of the feeding path of the print medium 50 and facing the print medium 50. The heating unit 30 heats and dries a print medium 50 to which ink has been applied.

The control unit 40 is made up of an MPU (Micro Processor Unit) and various types of memory, such as ROM (Read-Only Memory), RAM (Random Access Memory), and flash memory.

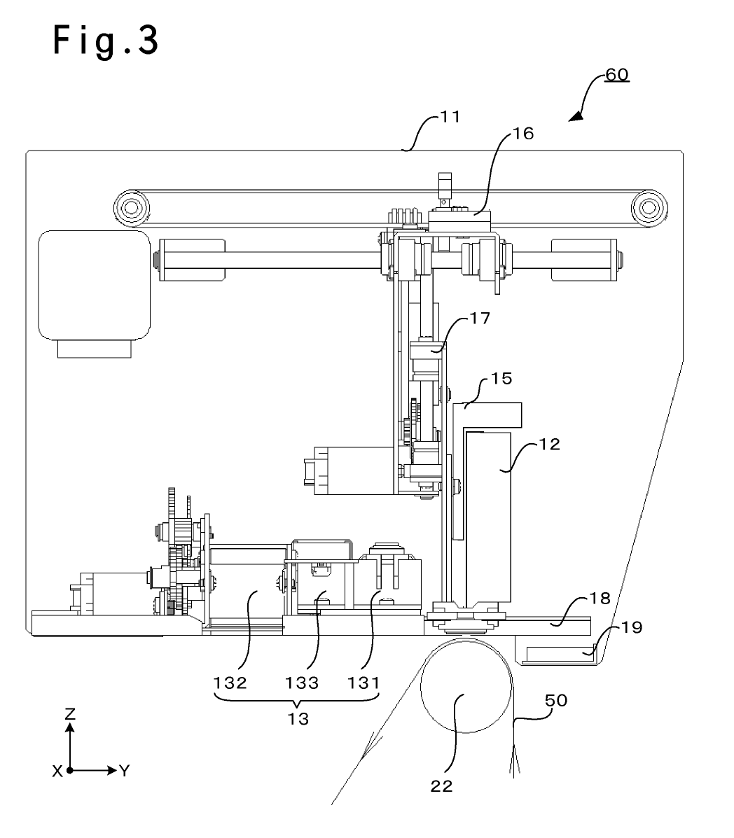

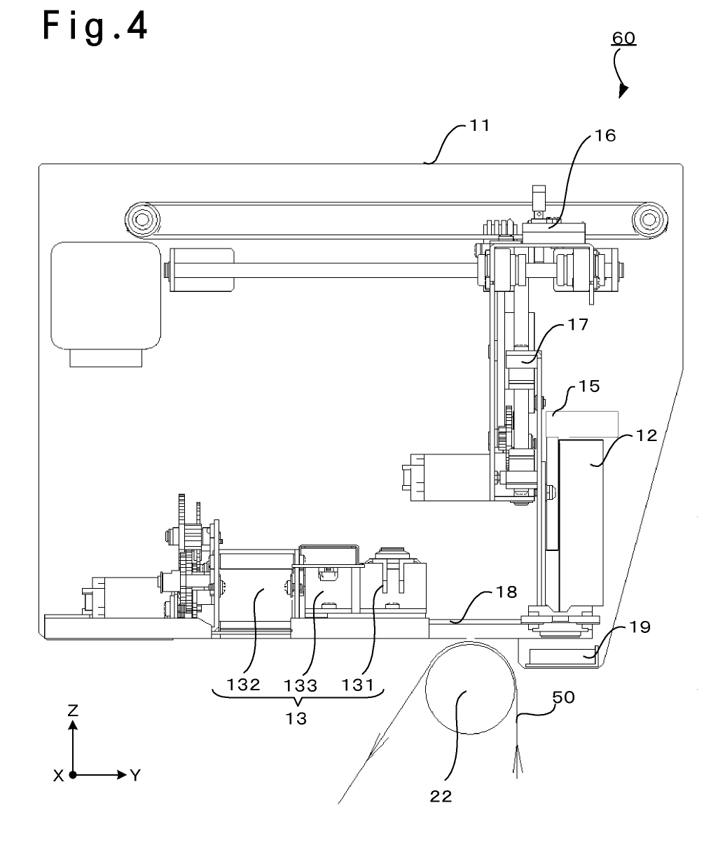

FIGS. 3 and 4 are cross-section diagrams of the print head apparatus 60 in the inkjet printer 1 shown in FIGS. 1 and 2. FIG. 3 illustrates the state wherein the print head 12 is in the print position.

In addition, FIG. 4 illustrates the state wherein the print head 12 is in the ejection position. The ejection position is the position where ink resident in the print head is ejected and discarded, typically when printing is paused.

For example, if printing stops for 30 sec or more, ink resident in the print head is eventually solidified and blocks the nozzle holes. When printing is paused, the control unit 40 moves the print head to the ejection position, and periodically ejects and discards the ink resident in the print head into the ejected ink receptacle 19. This operation is called a spit operation.

As illustrated in FIGS. 3 and 4, the print head apparatus 60 includes a print head carrier 15, a horizontal transport mechanism 16, a vertical transport mechanism 17, a supporting member 18, and a receptacle 19 in addition to the aforementioned chassis 11 and the print head 12.

The print head 12 has an approximately rectangular solid shape, and on the bottom surface thereof (i.e., the nozzle surface 14), a plurality of nozzle holes (not shown in the drawings) that eject ink supplied from ink cartridges (not shown in the drawings) are formed at predetermined intervals along the lengthwise direction (i.e., the direction parallel to the lengthwise direction of the platen roller 22) of the nozzle surface 14.

The maintenance mechanism 13 is provided with a cap unit 131, a wiper unit 132, and a cleaner unit 133. The cap unit 131, the wiper unit 132, and the cleaner unit 133 are disposed in series in the Y direction (i.e., the direction orthogonal to the direction in which the print head 12 moves close to and away from the platen roller 22, and orthogonal to the lengthwise direction of the platen roller 22).

The cap unit 131 holds a cap that covers the nozzle surface 14 of the print head 12 and prevents drying of the nozzle holes. When the inkjet printer 1 has stopped printing for a long time, such as when the print content changes, the cap unit 131 covers the nozzle surface 14 of the print head 12 with the cap in order to prevent ink from being solidified.

In addition, at the print end time or the print start time, the cap unit 131 creates a low-pressure state by drawing air out from inside the cap with a pump not shown in the drawings, thus aspirating and discharging ink out of the nozzle holes of the print head 12.

After the cap unit 131 has aspirated and discharged ink out of the nozzle holes of the print head 12, the wiper unit 132 scrapes ink remaining on the nozzle surface 14. The wiper unit 132 is provided with a scraper.

After the wiper unit 132 scrapes ink, the cleaner unit 133 dissolves and cleans off ink remaining on the nozzle surface 14. The cleaner unit 133 is made up of a compressible, porous material such as urethane foam impregnated with a cleaning fluid (i.e., solvent) that dissolves ink, as well as a case that houses the porous material.

The print head carrier 15 is a member that holds the print head 12 such that the nozzle surface 14 faces the platen roller 22.

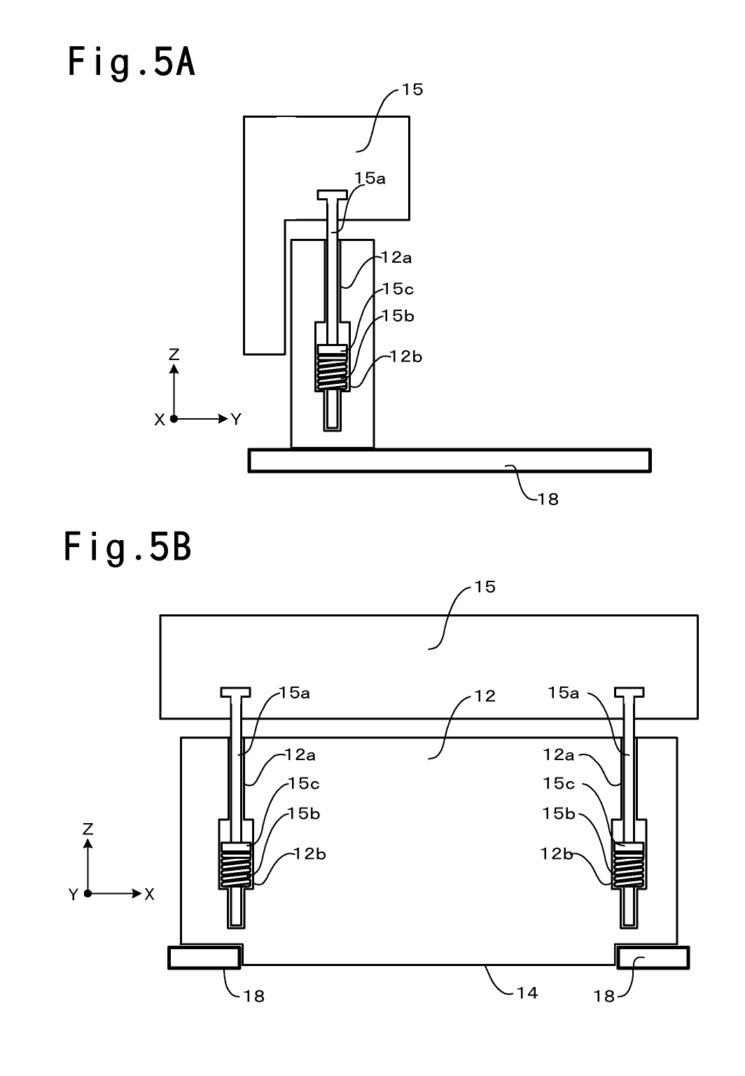

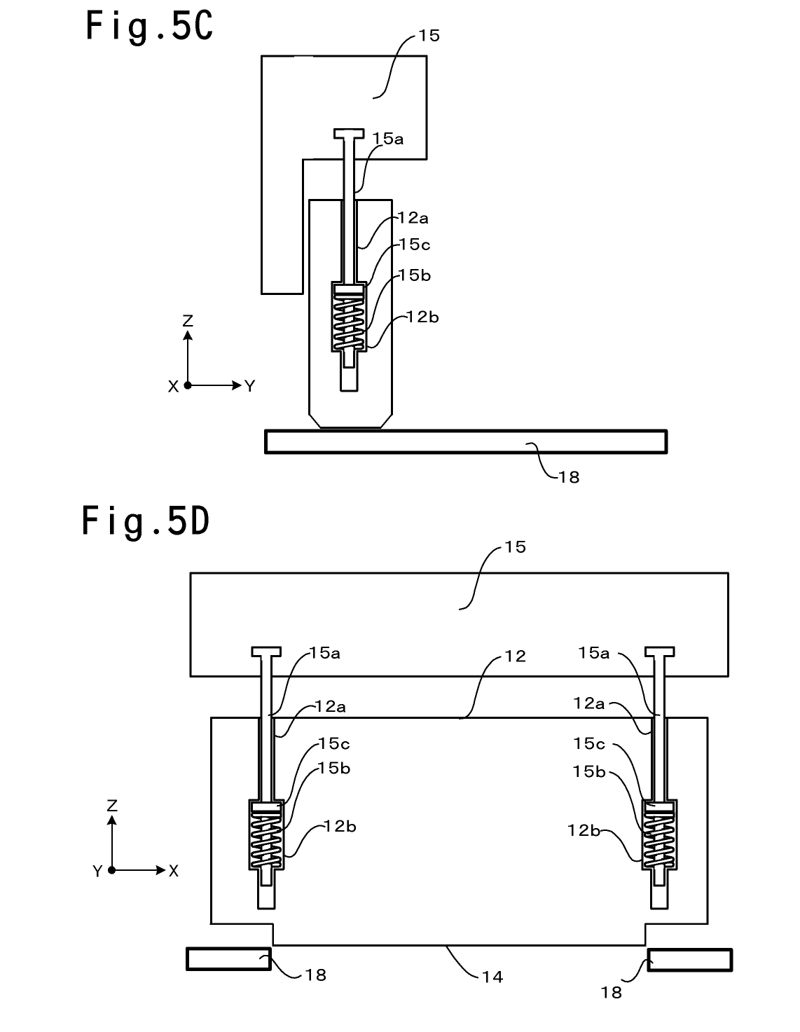

As illustrated in FIGS. 5A and 5B, a plurality of shafts (slide pins) 15a extend from the print head carrier 15 in the vertical direction (i.e., the Z direction; the direction in which the print head 12 moves close to and away from the platen roller 22). Coiled around the shafts 15a are coil springs 15b, one of whose ends is secured by large-diameter sections 15c.

The shafts 15a are inserted into slide holes 12a formed in the print head 12, with the coil springs 15b and the large-diameter sections 15c being disposed inside large-diameter sections 12b formed in the slide holes 12a.

By means of such a configuration, the shafts 15a extending from the print head carrier 15 are slidable inside the slide holes 12a of the print head 12. The print head 12 is in a state of being constantly impelled downward by the coil springs 15b.

The horizontal transport mechanism 16 and the vertical transport mechanism 17 transport the print head 12 in the horizontal direction (the Y direction) and the vertical direction (the Z direction). In so doing, the print head 12 is transported to the print position, the cap unit 131, the wiper unit 132, the cleaner unit 133, or the receptacle 19.

Secured to the chassis 11, the horizontal transport mechanism 16 supports the vertical transport mechanism 17 and transports the vertical transport mechanism 17 in the horizontal direction (the Y direction).

The vertical transport mechanism 17 supports the print head carrier 15 and transports the print head carrier 15 in the vertical direction (the Z direction).

As illustrated in FIGS. 3 and 4, the supporting member 18 is disposed parallel to either side of the chassis 11 and extends from the side of the platen roller 22 to the side of the receptacle 19. The supporting member 18 contacts both ends of the bottom of the print head 12 (portions where nozzles are not disposed). In so doing, the position of the print head 12 in the vertical direction is adjusted so as to be positioned in the print position where the print medium 50 is printed on the platen roller 22 and positioned in the ejection position where ink is ejected into the receptacle 19 and discarded.

As illustrated in FIGS. 5A and 5B, when the print head carrier 15 descends, the position of the print head 12 in the vertical direction (Z direction) is regulated by the supporting member 18, so that the position remains the same. The print head carrier 15 descends by a predetermined amount even after the print head 12 contacts the supporting member 18. In accordance with the continuing descent of the print head carrier 15 even after contacting the supporting member 18, the coil springs 15b are compressed between the shafts 15a and the print head 12, thereby producing force pushing the print head 12 to the direction of the supporting member 18. After descending until a predetermined pressing force is obtained, the print head carrier 15 is stopped.

FIGS. 5C and 5D illustrate the case wherein the print head 12 rises.

When the print head carrier 15 rises, the state of contact is released between the supporting member 18 and both ends of the bottom of the print head 12. As described earlier, the print head carrier 15 continues to descend a predetermined amount even after the print head 12 contacts the supporting member 18. For this reason, the rise amount of the print head carrier 15 and the rise amount of the print head 12 are not the same.

The supporting member 18 is constructed from a suitable material selected from among slide-grade (low frictional wear grade) materials constructed from nylon resin or similar substances with low kinetic friction coefficients. The supporting member 18 is secured to the chassis 11.

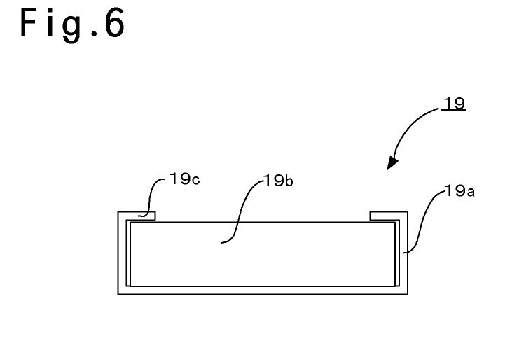

The receptacle 19 receives and stores ink ejected and discarded from the print head 12, and is constructed so as to be able to dispose of stored ink. Preferably, the receptacle 19 is made up of a tray 19a and a sponge-shaped (i.e., a porous material) absorbent pad 19b housed in the tray 19a, as illustrated in FIG. 6. The top end of the peripheral wall of the tray 19a is bent in the inward horizontal direction, and functions as guards 19c that hold down the absorbent pad 19b. By pulling an absorbent pad 19b out from between the guards 19c and inserting an absorbent pad 19b in between the guards 19c, the absorbent pad 19b can be replaced. It should be appreciated that the absorbent pad 19b is not limited to a porous material, and may also be an absorber that works by chemical reactions, such as a polymer absorber, for example.

When the printer is paused, the spit operation causes the print head 12 to eject and discard ink into the receptacle 19. In a spit operation, ink inside the nozzle holes of the print head 12 is not aspirated and discharged. For this reason, it is not necessary for the receptacle 19 to include a pump that reduces pressure by drawing air out from inside the cap like the cap unit 131. The construction of the receptacle 19 is simple, and the receptacle 19 can be made shallow.

The receptacle 19 is disposed near the platen roller 22 and faces the maintenance mechanism 13 with the platen roller 22 in the middle. In addition, the receptacle 19 may also be disposed in a position such that when the print head 12 moves in the horizontal direction (the Y direction), the top surface of the receptacle 19 does not interfere with the bottom surface (the nozzle surface 14) of the print head 12. For example, the receptacle 19 may be disposed in a position slightly lower than the top surface of the platen roller 22, or in other words, in a position slightly lower than the top surface of the supporting member 18 (i.e., the bottom surface of the print head 12 (the nozzle surface 14)). By disposing the receptacle 19 in this manner, when the print head 12 is moved in the horizontal direction (the Y direction) and positioned over the receptacle 19, the top surface of the receptacle 19 and the bottom surface of the print head 12 (the nozzle surface 14) do not touch. In other words, the print head 12 is moved from the print position to the ejection position simply by moving in the horizontal direction (the Y direction) by means of the horizontal transport mechanism 16. Similarly, the print head 12 returns to the print position from the ejection position simply by moving in the horizontal direction (the Y direction).

Next, the operation of the inkjet printer 1 having the above configuration will be described.

### (1) Print Operation

When printing onto a print medium 50, the control unit 40 controls the vertical transport mechanism 17 over the print position to cause the print head 12 to descend, thereby causing both ends of the bottom of the print head 12 to contact the supporting member 18, as illustrated in FIGS. 5A and 5B. In so doing, the position of the print head 12 in the vertical direction is regulated at the print position by the supporting member 18. Subsequently, the print head 12 is further made to descend a predetermined amount, such as approximately 5 mm, for example. However, since the position of the print head 12 in the vertical direction is regulated at the print position by the supporting member 18, the coil springs 15b are compressed instead of the print head 12 actually descending, and a pressing force is produced. In so doing, the print head 12 is pressed against the supporting member 18 by a predetermined pressing force. However, since the pressing force is due to the elasticity of the coil springs 15b, the force whereby the print head 12 presses against the supporting member 18 does not become excessive.

Subsequently, the control unit 40 may, for example, use the output of a rotary encoder installed on the platen roller 22 to determine that feeding of the print medium 50 has started, as well as to determine how far the print medium 50 has been fed. By synchronously driving the print head 12, the control unit 40 prints onto the print medium 50.

During print operation, the print head 12 is damped by being pressed against the supporting member 18 by a predetermined pressing force, reducing the likelihood of vibration, and thus reducing the likelihood of degradation of print quality due to vibration.

### (2) Spit Operation

If feeding of the print medium 50 stops due to conditions in an upstream or downstream process or other factors, then the control unit 40 may, for example, use the output of a rotary encoder installed on the platen roller 22 to determine that feeding of the print medium 50 has stopped. In response to this determination, the control unit 40 pauses operation of the inkjet printer 1, and puts the print head 12 in standby at the print position (i.e., the state shown in FIG. 3 is maintained). Simultaneous to the stopping of the operation of the inkjet printer 1, the control unit 40 also activates a timer not shown in the drawings, such as an internal software timer.

With printing in the stopped state, if the timer detects that a predetermined amount of time (i.e., a degree of time during which the ink inside the ink nozzles of the print head 12 will not coagulate, such as 20 to 30 sec) has elapsed, then the control unit 40 drives the horizontal transport mechanism 16, transports the print head 12 to a position directly above the receptacle 19 (i.e., the ejection position), thereby realizing the state shown in FIG. 4. As described earlier, the height of the top surface of the receptacle 19 is lower than the top surface of the platen roller 22, and thus the print position and the ejection position are at the same height. For this reason, the print head 12 can be moved from the print position to the ejection position simply by moving in the horizontal direction (the Y direction) by means of the horizontal transport mechanism 16.

In the present embodiment, the supporting member 18 is disposed being parallel to either side of the chassis 11 and extending from the side of the platen roller 22 to the side of the receptacle 19, as illustrated in FIGS. 3 and 4.

For this reason, the control unit 40 is able to slide the print head 12 while contacting the supporting member 18, and thus move the print head 12 from the print position to the ejection position by driving the horizontal transport mechanism 16, without driving the vertical transport mechanism 17. The print head 12 is pressed against the supporting member 18 even while moving horizontally, and thus is damped.

When the print head 12 moves to the ejection position, the control unit 40 conducts a spit operation. More specifically, the control unit 40 drives the print head 12 to discharge the ink resident inside the print head 12 towards the receptacle 19. In addition, the receptacle 19 receives and retains the discharged, old ink in the absorbent pad 19b. Since there is a limit to the amount of ink that can be absorbed and retained by the absorbent pad 19b of the receptacle 19, the user replaces the absorbent pad 19b as necessary or periodically.

When discharge (ejection) of the old ink is completed, the control unit 40 again drives the horizontal transport mechanism 16 and returns the print head 12 to the print position, thereby realizing the state shown in FIG. 3. The print head 12 is still pressed against the supporting member 18 during horizontal movement and is thus damped.

When the print head 12 returns to the print position, the control unit 40 resets and reactivates the timer, and repeats the operations described above until operation of the inkjet printer 1 is resumed.

The print head 12 is transported in the horizontal direction with its vibration under control, so it moves back to the print position and right after that, it can initiate print operation when necessary.

### (3) Maintenance Operation

When launched (or alternatively, after print operation has stopped for a long time), the control unit 40 moves the print head 12, fits the cap unit 131 thereon, and subsequently reduces pressure inside the cap unit 131 to thereby cause solidified ink inside the print head 12 to be aspirated.

In addition, when appropriate, the control unit 40 transports the print head 12 to the wiper unit 132 and then drives the wiper unit 132 to scrape ink adhering to the nozzle surface of the print head 12.

In addition, when appropriate, the control unit 40 moves the print head 12 to the cleaner unit 133 and then causes a cleaning pad in the cleaner unit 133 to touch the nozzle surface 14, thereby cleaning the nozzle surface 14.

As a result of the control unit 40 repeating the above operations, high-quality printing is conducted.

In the inkjet printer 1 configured as described above, printing (i.e., the ejection of ink) is conducted while the print head 12 is in a state of being pressed against the supporting member 18 (i.e., a damped state). For this reason, vibration or other movement of the print head 12 is unlikely to occur, print distortions due to vibration of the print head 12 are prevented, and high-quality printing can be conducted.

In addition, when the print head 12 is transported in the horizontal direction in order to conduct the spit operation (i.e., the operation to eject and discard ink), the print head 12 is slid at low friction while being pressed against the supporting member 18. For this reason, the print head 12 is prevented from vibrating, thereby enabling rapid operation after the completion of movement.

It should be appreciated that the present invention is not limited to the above embodiment, and that various modifications and applications are also possible.

In the above embodiment, an receptacle 19 is disposed, but it is not strictly necessary to provide such a component. In this case, the supporting member 18 may be disposed so as to contact the print head 12 in the print position.

The configuration for pressing the print head 12 against the supporting member 18 is arbitrary, and not dependent on the configuration shown in FIGS. 5A to 5D. For example, pressing force may be applied by means of flat springs, rubber, or another similar elastic member, instead of the coil springs 15b. In addition, pressure may also be applied directly by the vertical transport mechanism 17.

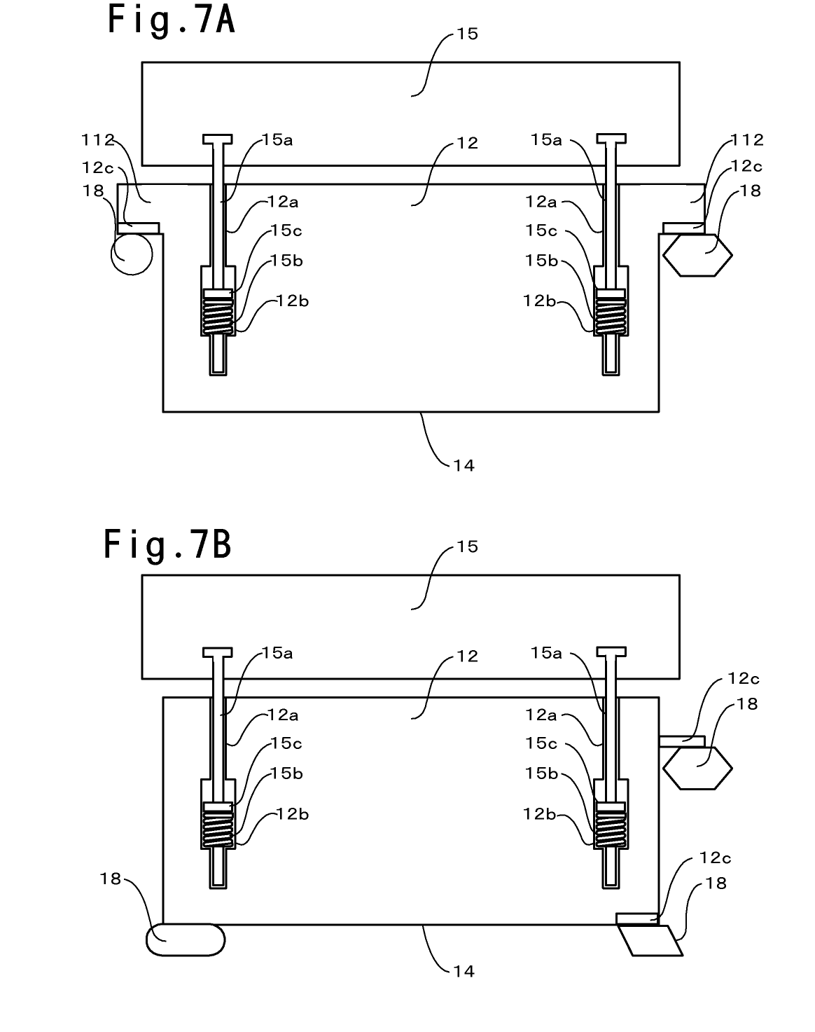

As another example, in the above embodiment, the supporting member 18 is disposed so as to contact and support both ends of the bottom of the print head 12. However, it is possible for the supporting member 18 to contact and support the print head 12 at an arbitrary location within the range where printing is not obstructed. For example, as illustrated in FIG. 7A, projections 112 may be disposed on both ends of the print head 12 and configured to be supported by the supporting member 18. In addition, as illustrated in FIG. 7B, both ends of the bottom surface (the nozzle surface 14) of the print head 12 may be configured to be supported by the supporting member 18.

A member having a cross-section shaped like an elongated rod is described as the supporting member 18 herein by way of example, but as illustrated in the examples in FIGS. 7A and 7B, the cross-section may also be circular or polygonal, for example.

In addition, the supporting member 18 herein is constructed from a low-friction material, but as illustrated in FIGS. 7A and 7B, low-friction materials 12c may also be disposed, applied in a coat, or otherwise provided at the contact portions of the print head 12.

In the above embodiment, the peak of the platen roller 22 and the top surface of the receptacle 19 are approximately the same height, and the supporting member 18 is disposed approximately horizontally. However, height in the present invention does not mean height in the direction of gravity, but rather means height based on the horizontal direction (the Y direction) in which the print head 12 is moved by the horizontal transport mechanism 16. In FIGS. 3 and 4, the aforementioned height means the height in the Z direction, and thus in the case where the inkjet printer 1 itself is disposed in a tilted position, the horizontal line becomes similarly tilted.

In the above embodiment, the receptacle 19 is made up of a tray 19a, an absorbent pad 19b, and guards 19c. However, an arbitrary configuration can be adopted, as long as the configuration of the receptacle 19 is able to receive and accumulate ink that has been ejected and discarded, and then automatically or manually dispose of the ink. For example, the receptacle 19 may be configured to have a socket that receives ejected and discarded ink, and a container (tank) that stores ink.

In addition, in the above embodiment, the absorbent pad 19b is configured to be pulled out from between the guards 19c of the tray 19a. However, a configuration is also possible wherein the absorbent pad 19b can be pulled out together with the tray 19a itself.

In addition, in the above embodiment, the platen roller 22 is disposed between the cap unit 131 and the receptacle 19. However, the installation position of the receptacle 19 is not limited to this. For example, the receptacle 19 may also be disposed between the platen roller 22 and the cap unit 131.

Furthermore, it is not necessary for the absorbent pad 19b to be maintained at the same approximate height as the platen roller 22, and the absorbent pad 19b may be disposed in a position shifted in the Z direction. In this case, either the supporting member may be divided and disposed as a member for the print position and a member for the ejection position, or the supporting member may be formed having a sloped shape. However, since movement in not only the Y direction but also the Z direction is produced when the print head 12 is moved in this case, it is preferable for the absorbent pad 19b and the platen roller 22 to be at approximately the same height.

In addition, a configuration is also possible wherein the supporting member is not provided at the ejection position, and instead the supporting member is only disposed near the print position.

However, as described earlier, at the print position, the print head 12 is pressed against the supporting member 18 by a predetermined pressing force produced as a result of the coil springs 15b being compressed. If the supporting member is only provided near the print position and the state of contact is released between the print head 12 and the supporting member while the print head 12 is being transported to the ejection position by the horizontal transport mechanism 16 (i.e., if the supporting member ends partway), then the print head 12 is lowered by an amount (5 mm, for example) corresponding to the amount that the print head carrier 15 was made to descend in order to compress the coil springs 15b.

In such a case, when the print head 12 attempts to return to the print position from the ejection position, the print head 12 is unable to smoothly return up onto the supporting member due to the amount the print head 12 was lowered, and thus the print head 12 and the supporting member may collide. Consequently, in order for the print head 12 to smoothly return up onto the supporting member, it is necessary to make the shape of the end of the supporting member sloped, and in some cases, it may be necessary to raise the print head 12 by means of the vertical transport mechanism 17.

In addition, the configuration of the maintenance mechanism 13 is arbitrary, and can be suitably modified.

The timing of spit operation performance is optional as well and should be appropriately selected according to the environment in which each printer operates.

Herein, a platen refers to a member that holds a print medium at a regular position. The platen is not limited to having a roller shape like the platen roller 22, and may also be flat.

In addition, in the above embodiment, the control unit 40 uses the output from a rotary encoder installed on the platen roller 22 to determine starting and stopping of transport of the print medium 50, as well as to determine how far the print medium 50 has been transported. However, the inkjet printer 1 may be provided with a motor for rotating the platen roller 22, and the control unit 40 may control the motor to control the starting and stopping of transport of the print medium 50, as well to control how far the print medium 50 is transported.

In addition, in the above embodiment, when the discharge of old ink is completed, the control unit 40 again uses the horizontal transport mechanism 16 to return the print head 12 to the print position shown in FIG. 3. However, when the discharge of old ink is completed, it is not strictly necessary for the control unit 40 to return the print head 12 to the print position. When the discharge of old ink is completed, the control unit 40 may also keep the print head 12 at the ejection position shown in FIG. 4 and discharge ink resident inside the print head 12 into the receptacle 19 every time a predetermined amount of time elapses. The control unit 40 may also eject and discard ink immediately before resuming printing, and then subsequently use the horizontal transport mechanism 16 to return the print head 12 to the print position shown in FIG. 3. In so doing, the quality of printing can be improved.

The above thus describes embodiments of the present invention. However, it should be understood that various modifications and combinations required by design conditions and other factors are also included within the scope of the invention corresponding to that described in the claims and the specific examples described in the embodiments.

In addition, the present application is based on Japanese Patent Application No. 2007-178941 filed on Jul. 6, 2007, the entire content of which, including specification, claims, and drawings, is hereby incorporated by reference.

### INDUSTRIAL APPLICABILITY

The present invention can be used in printers.

1. A printer, comprising:
a platen that holds a print medium;
a print head that prints at a predetermined print position by ejecting ink from nozzle holes toward the print medium held by the platen;
a supporting member that supports the print head; and
a pressing section that presses the print head against the supporting member.

2. The printer according to claim 1, wherein
the supporting member is disposed at a position facing opposite ends of the print head, and
the pressing section presses the print head against the supporting member such that the opposite ends of the print head contact the supporting member.

3. The printer according to claim 1, wherein
the supporting member supports the print head at the print position, and
the pressing section presses the print head against the supporting member at the print position.

4. The printer according to claim 3, wherein the pressing section suppresses vibration of the print head as a result of pressing the print head against the supporting member.

5. The printer according to claim 1, further comprising:
an ejected ink receptacle, disposed in a predetermined ejection position, that absorbs and retains ink ejected and discarded by the print head in order to prevent ink resident in the print head from being solidified; and
a transporting section that transports the print head between the print position and the ejection position;
wherein
the supporting member is configured from a flat guide extending between the print position and the ejection position, and supports the print head between the print position and the ejection position, and
the pressing section presses the print head against the supporting member between the print position and the ejection position.

6. The printer according to claim 5, wherein
the transporting section transports the print head and the pressing section between the print position and the ejection position, and
while being transported between the print position and the ejection position by the transporting section, the pressing section presses the print head against the supporting member.

7. The printer according to claim 5, further comprising:
a cleaning mechanism that cleans the print head;
wherein
the transporting section transports the print head among the print position, the ejection position, and a cleaning position where the print head is cleaned by the cleaning mechanism.
